(19) United States
(12) Patent Application Publication
(10) Pub. No.: US 2010/0107735 A1
(43) Pub. Date: May 6, 2010

(54) Gas Sensor

(76) Inventor: Igor Pavlovsky, Austin, TX (US)

Correspondence Address: Matheson/ Keys PLLC, 7004 Bee Cave Rd., Austin, TX, 78746, US

(21) Appl. No.: 12/685,629

(22) Filed: Jan. 11, 2010

Related U.S. Application Data
(63) Continuation-in-part of application No. 11/524,698, filed on Sep. 21, 2006, now Pat. No. 7,647,813.
(60) Provisional application No. 60/719,548, filed on Sep. 22, 2005.

(51) Int. Cl. G01N 7/00; G01N 29/02; G01N 19/10

(52) U.S. Cl. 73/24.04; 73/29.02

(57) ABSTRACT

A gas sensor with instant response uses one or more oscillators while no chemical reactions or other material modifications are involved. Sensor can be used in any application to measure a percent range of gas concentrations, or mass of the absorbed gas.

This application is a continuation-in-part application of U.S. patent application Ser. No. 11/524,698, which claims priority to U.S. Provisional Patent Application Ser. No. 60/719,548, both of which are hereby incorporated by reference herein.

### TECHNICAL FIELD

This invention relates to gas sensors, and more particularly to gas sensors utilizing oscillators and environmental sensors.

### DESCRIPTION OF DRAWINGS

FIG. 1 illustrates an apparatus for measuring a frequency difference between oscillators;

FIG. 2 illustrates a graph of sensitivity of a sensor;

FIG. 3 illustrates another apparatus for measuring a frequency difference between oscillators;

FIG. 4 illustrates a graph of sensitivity of a sensor;

FIG. 5 illustrates a circuit for outputting results of embodiments of the present invention;

FIG. 6 illustrates a sensor utilizing a nanowire or nanotube;

FIG. 7 illustrates an exemplary application of embodiments of the present invention; and

FIGS. 8-11 illustrate embodiments of the present invention.

### DETAILED DESCRIPTION

Hydrogen is known as the element with the smallest atomic mass. In a gas mixture in thermodynamic equilibrium, molecules have a mean energy of ˜3/2 kT, whether they are molecules of hydrogen, nitrogen, oxygen, etc. The momentum of a molecule is my, where m is molecular mass, and v is the mean molecular velocity equal to (8 kT/πm)^{1/2}. So, the momentum of a gas molecule at a given temperature will depend on its mass as (m)^{1/2}. The difference in momentum and size (effective diameter) of molecules leads to the difference in other macroscopic parameters of gases, such as viscosity and diffusion rate.

During oscillations in a gas environment, a vibrating object such as tuning fork tines impart momentum to gas molecules resulting in mechanical energy loss in the tines. This loss causes a change in the resonant oscillation frequency of the fork, and the frequency shift will depend on a momentum that the tines impart to gas molecules. This means that in a gas that contains light molecules, such as hydrogen, the losses due to interaction with the gas molecules will be less than in an environment without hydrogen. Hence, the frequency of oscillations will be higher in an environment having a presence of hydrogen.

In a tuning fork quartz oscillator, the fork tines symmetrically vibrate in an anti-phase flexure mode, wherein the tines move in opposite directions against each other at any moment in time. The speed at which the tines oscillate can be estimated as follows. The amplitude of the tine deflection is approximately 60 nm/V. If the driving voltage on the tines is about 1V, then at a frequency of 32768 Hz, the tines will have a characteristic speed of ˜2 mm/sec. That is much less than the speed of gas molecules (hundreds of meters per second), and it is possible to consider a quasi-static case for this interaction. Therefore, it is mostly the macroscopic characteristics of gases that will affect tuning fork oscillation frequency.

The described tuning fork sensor may not be selective to a particular gas, and other light gases (e.g., helium) may interfere with the gas to be served. To avoid interference, it is possible to use gas-permeable membranes (e.g., Pd (palladium) membranes when sensing hydrogen) to improve selectivity.

The frequency change in the tuning fork resonator is usually small, so a differential frequency detection method may be used for the detection of small frequency deviations. Along with frequency, the quality factor Q and the electric impedance of the tuning fork resonator changes as the oscillation energy is dissipated in gas environment.

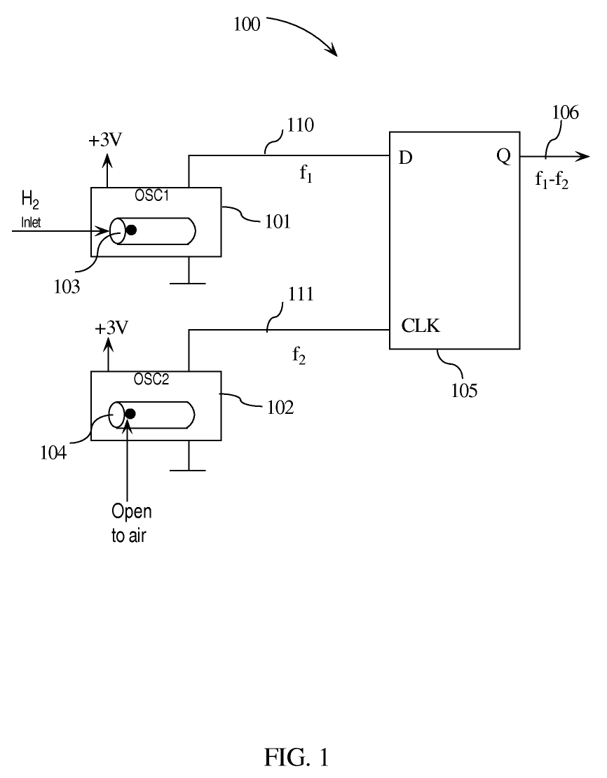

FIG. 1 illustrates an apparatus 100 with a plurality of ECS-327SMO type oscillators 101 . . . 102, which may be used for gas detection. The tuning fork oscillator cans' tops 103 . . . 104 may be sanded off for access of gas, and the oscillators' outputs 110, 111 connected to D and CLK inputs of a D flip-flop trigger 105. The oscillator (OSC1) 101 may be located in an environment suspected of containing a particular gas. The reference oscillator (OSC2) 102 may be used to account for changes in gas composition (such as humidity changes) and for temperature compensation. The frequency of the oscillator 101 will increase with the gas concentration. The frequency difference at the flip-flop output 106 is thus proportional to the gas concentration.

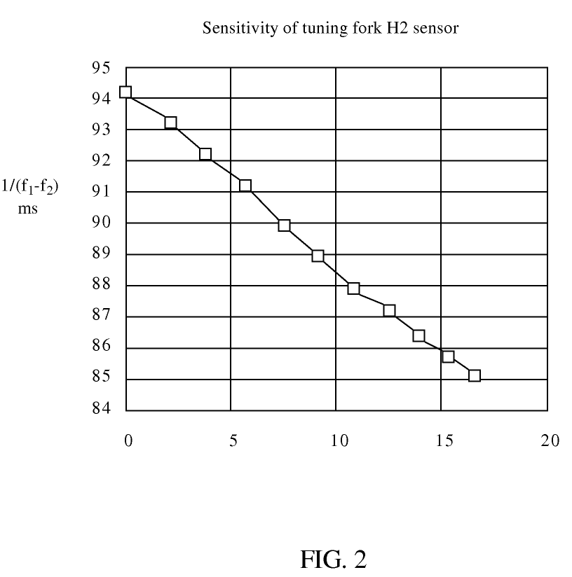

By way of example, the sensor 100 may be characterized using hydrogen gas mixed with air at volume concentrations of 0 to 16% at room temperature. The hydrogen-air mixture may be prepared using two 100 sccm mass flow controllers. The interval between the frequency beats may be measured using a Tektronix CDC250 counter. The response of the sensor 100 to hydrogen is quite linear in all ranges of concentrations. As can be seen in FIG. 2, a 9% change in the differential frequency may be observed when 16% H₂ concentration is achieved in the chamber of oscillator 101.

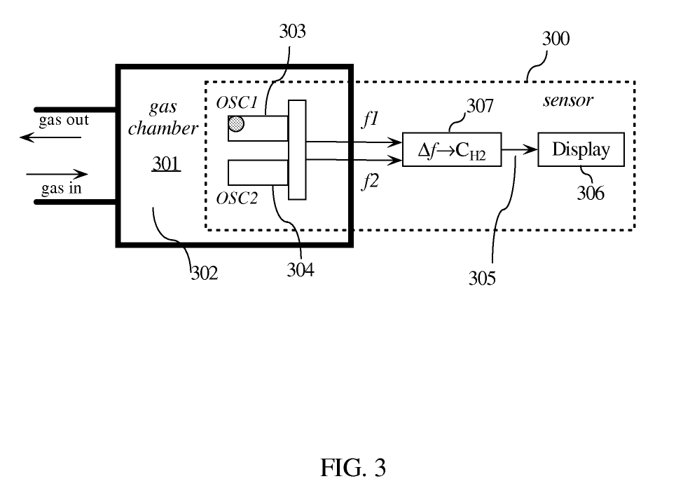

FIG. 3 illustrates a sensor 300 where two oscillators 303, 304 are used to detect a gas (e.g., hydrogen) in a gas chamber 301. Sensor 300 has the reference oscillator 304 sealed (the can's top is not sanded off) to protect from access to the gas to be sensed and/or measured. Along with the open oscillator 303 they can be placed into the measured gas environment next to each other. As noted above, a gas-permeable membrane 302 may be used. In this embodiment, cross-compensation can be performed for the temperature, but not for humidity changes.

The concentration of the gas can then be calculated as follows:

f₁=f₁₀+kC_{H2},

f₂=f₁₀+f₁₂,

Δf=f₁−f₂=f₁₀+kC_{H2}−f₁₀+f₁₂=kC_{H2}+f₁₂

where f₁₀ is the frequency of oscillator OSC1 303 without the gas, f₁₂ is the difference between the frequencies of OSC1 303 and OSC2 304 without the gas, k is the proportionality factor, and C_{H2} is the concentration of the gas. The last expression can be recalculated as follows:

C_{H2}=(Δf−f₁₂)/k

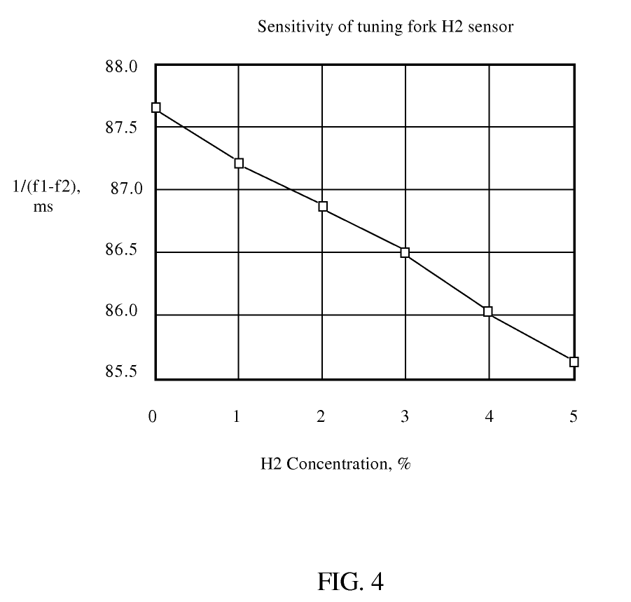

By way of example, test results for the sensor 300 for sensing hydrogen with sealed and open can oscillators are shown in FIG. 4. The sensor 300 was tested at room temperature, the flow rate of nitrogen was 200 sccm, and the flow rate of hydrogen changed from 0 to 10 sccm. The sensor 300 shows a near linear response to H₂ concentration changes.

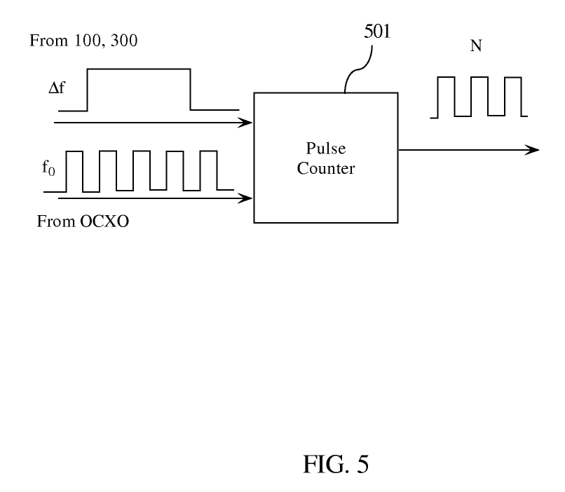

Referring to FIG. 5, since a difference in frequencies of two oscillators can be as small as several Hz, it may be more convenient to measure time intervals between two frequency beating pulses. In this case, a separate high-frequency oscillator (not shown) may be used to fill the time intervals with pulses at a fixed frequency f₀. For precision measurements, oven-controlled crystal oscillators (OCXO) may be used to generate such pulses. The time interval between the frequency beatings is

T=1/Δf=1/(f₁−f₂)=1/(kC_{H2}+f₁₂)

If the OCXO stabilized generator has a frequency of f₀, then the number of pulses at the output N of pulse counter 501 is

N=f₀T=f₀/Δf=f₀/(kC_{H2}+f₁₂)

In another embodiment, a device for measuring oscillation parameters of the tuning fork detects changes in Q factor and an impedance of the tuning fork as hydrogen will change the energy that is dissipated by the tuning fork tines. The energy dissipation in the tuning fork can described as follows.

If a mechanical system such as a tuning fork has a mechanical resistance R_{M}, the quality factor Q at a resonant frequency f₀ is

Q˜f₀/R_{M}

The mechanical resistance R_{M} is a function of the gas viscosity V, and thus R_{M} can be described with the following series

R_{M}=R_{M0}(1+c₁V+c₂V²+ . . . )

where c1, c2, . . . , are the proportionality coefficients. For media with low viscosity, such as a gas, this can be rewritten as

R_{M}=R_{M0}(1+c₁V)

where R_{M0} is the mechanical resistance in vacuum and does not depend on a gas viscosity.

Hydrogen has approximately two times lower viscosity than air (8.4×10⁻⁶ Pa*s vs. 17.4×10⁻⁶ Pa*s at 0° C.), and, hence, the mechanical resistance will decrease at higher relative hydrogen concentrations. Thus:

R_{M}=R_{M0}(a−bC_{H2})

where a and b are functions of viscosities of hydrogen and a balanced gas (such as air), and C_{H2} is a relative concentration of hydrogen in the gas mixture. Then the concentration can be defined as

C_{H2}˜(a−f₀/QR_{M0})/b

where Q can be measured experimentally. The quality factor can be easily found when the quartz tuning fork is a part of an electrical circuit, since, by definition

Q=f₀/Δf

Measuring Δf may be performed by conventional methods used in electronics (frequency sweeping around f₀, measuring amplitude attenuation of oscillation pulses (damping factor), etc.). Since the electric impedance is also a function of the quality factor

|Z(ω)|²˜(1/Q²−1)+(ω/ω₀)²+(ω₀/ω)²

it may be used for determination of hydrogen concentration as well.

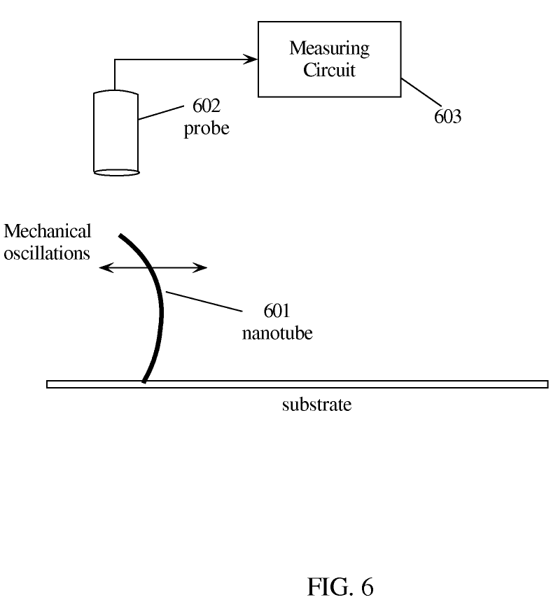

FIG. 6 illustrates an apparatus based on measurements of the frequency and/or the Q factor of a periodic movement (vibration) of a nanowire or a nanotube 601, such as a carbon nanotube, in flexure mode. The measurement system 603 of the sensor will include a means to detect and quantify such oscillations. Nanotube 601 vibrates due to an applied external force (not shown), such as mechanical or electrostatic force. An electric probe 602 coupled to the nanotube 601 either by field electron emission to/from the nanotube 601, or through the capacitance between the nanotube 601 and the probe 602, or by any other equivalent coupling mechanism. The probe 602 forms a part of the measuring electric circuit 603 that can measure deviations in coupling parameters (such as capacitance) and determine the frequency of these deviations.

As described above, the vibration frequency of the nanotube 601 or nanowire will depend on the viscosity of a surrounding gas, which, in turn, will depend on the concentration of the gas.

By way of example, the sensitivity range of the sensor is 0 to 100% H₂, with a detectivity limit of at least 1%, as can be seen from the sensitivity graphs shown above in FIGS. 2 and 4. The lower flammability level of hydrogen is 4%, and lower explosive limit (LEL) is 17%.

A gas sensor based on the kinetic characteristics of a gas, such as its molecular mass, viscosity, diffusion, etc., depends not only the gas concentration but also the characteristics of the environment, such as pressure, humidity, and temperature. Embodiments of the present invention utilize a combination of sensors to more accurately calculate the gas concentration.

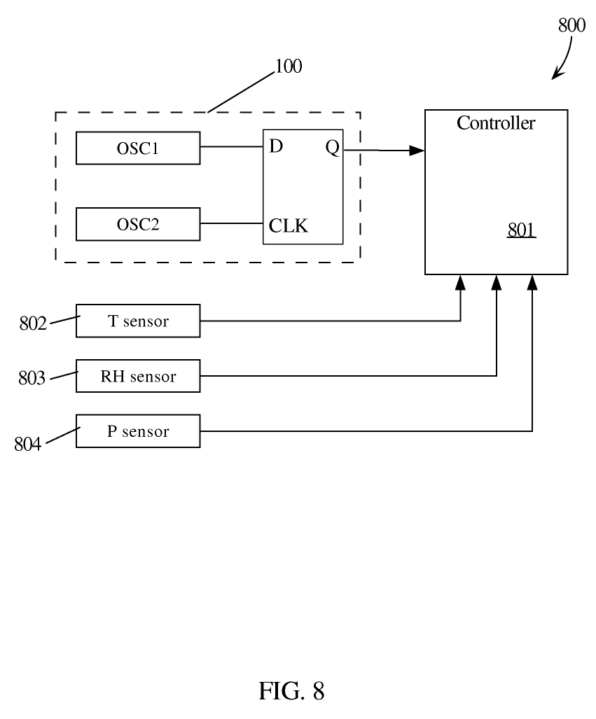

FIG. 8 illustrates a sensor system 800 that comprises electro-mechanical oscillators in a configuration as described above with respect to FIGS. 1-6 (e.g., apparatus 100), a temperature (T) sensor 802, a pressure (P) sensor 804, and a humidity (RH) sensor 803. A Sensirion SHT-75 temperature/humidity sensor may be used for the T sensor 802 and the RH sensor 803, and a ICS-1451 pressure sensor may be used for the P sensor 804.

An accurate signal for gas concentration may be calculated using an algorithm determined by circuitry in controller 801 that has the frequency difference, pressure, temperature, and gas humidity as variables. A multiple linear regression may be used, and the algorithm is applied to the data obtained while testing the sensor in environments with different temperature, humidity, pressure, and gas concentrations. The obtained coefficients are stored in the memory of the sensor controller 801 to further calculate the gas concentration using a linear or quadratic equation, as further described hereinafter.

The response of different tuning fork oscillators from even the same manufacturer may be different for the same detected gas, and if the response of two tuning forks is similar for one gas, it may be different for the other gas. Since the oscillators are not specific to any gas, such difference in response, which may be caused by mechanical imperfections in oscillator packaging, quartz crystals, electronics, etc., may be used to create some of specificity to distinguish between the two or more gases. In this case, several oscillators may be measured with different gases, and then a multiple regression method may be used to calculate the relevant concentrations.

This approach may also be used to non-selectively detect the mass of adsorbed gas contaminants if the sorbent is deposited on the open to the environment oscillator. For example, for activated carbon sorbent, the sorption capacity is quite high that results in a several percent increase in the sorbent mass. The sensors described herein may be able to detect the retaining capacity of the sorbent based on the frequency difference between the open and the sealed oscillator. The frequency of the open oscillator increases if more gas is absorbed in the sorbent, while the frequency of the sealed oscillator remains constant.

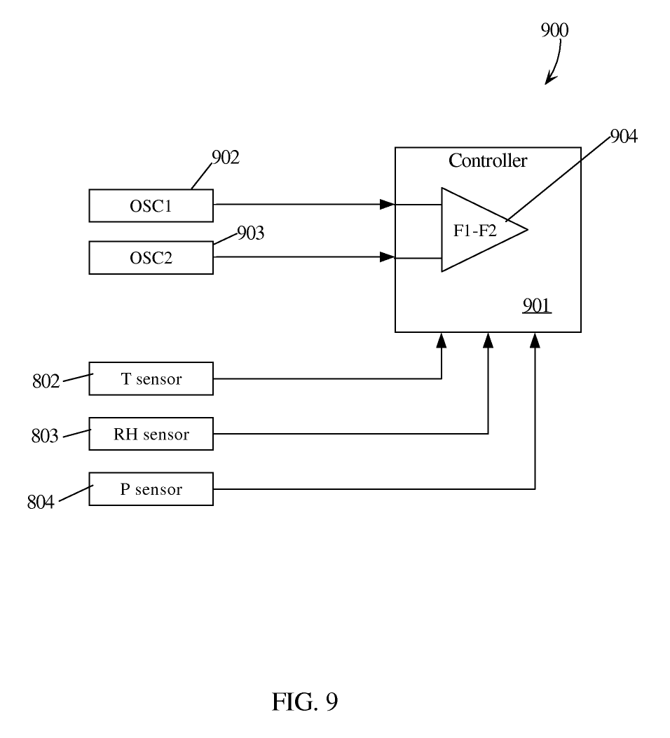

FIG. 9 illustrates a sensor system 900 that comprises electro-mechanical oscillators 902 . . . 903 similar to oscillators 101 . . . 102. A temperature (T) sensor 802, a pressure (P) sensor 804, and a humidity (RH) sensor 803 are similar to those as described above with respect to FIG. 8. A differential amp 904 determines the frequency difference from the outputs of oscillators 902 . . . 903. An accurate signal for gas concentration may be calculated using an algorithm determined by circuitry in controller 901 that has the frequency difference, pressure, temperature, and gas humidity as variables, in a manner as similarly described with respect to FIG. 8.

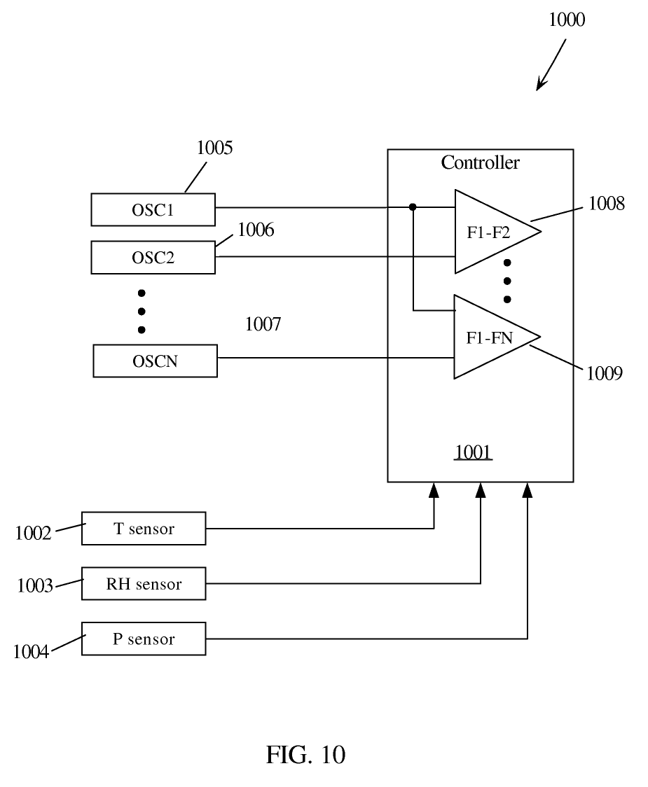

FIG. 10 illustrates a sensor system 1000 that comprises more than two electro-mechanical oscillators 1005, 1006, . . . 1007 similar to oscillators 101 . . . 102. One or more of the oscillators may be sealed in a hermetic packaging, while other oscillators may be exposed to one or more environments that may contain one or more gases to be sensed. A temperature (T) sensor 1002, a pressure (P) sensor 1004, and a humidity (RH) sensor 1003 are similar to those as described above with respect to FIG. 8. A plurality of differential amps 1008 . . . 1009 determine the frequency difference from the outputs of oscillators 1005, 1006, . . . 1007. An accurate signal for gas concentration may be calculated using an algorithm determined by circuitry in controller 1001 that has the frequency difference, pressure, temperature, and gas humidity as variables, in a manner as similarly described with respect to FIG. 8.

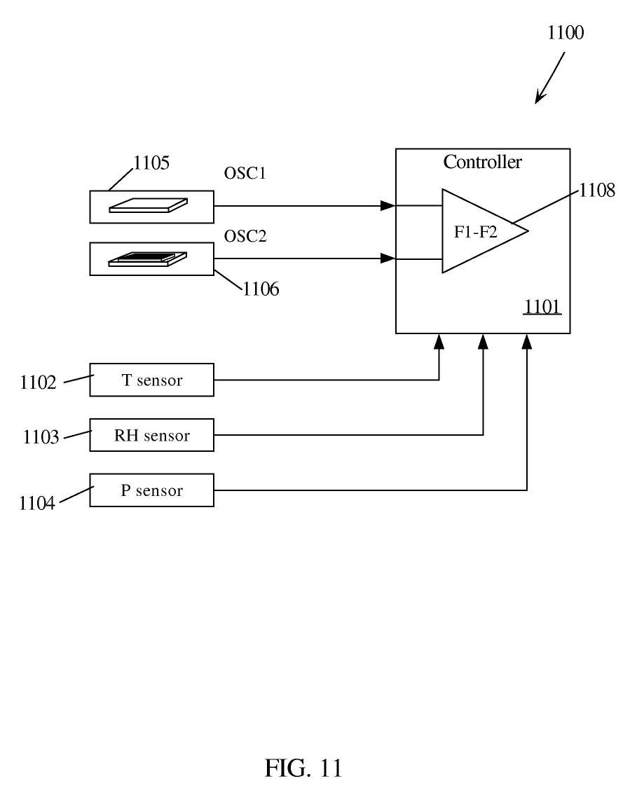

FIG. 11 illustrates a sensor system 1100 that comprises electro-mechanical oscillators 1105 . . . 1106 similar to oscillators 101 . . . 102. One or more of the oscillators (e.g., 1105) may be sealed in a hermetic packaging. One or more of the oscillators may comprise a gas sorbent coating and exposed to a gas-containing environment. When the gas is absorbed by the sorbent, the mass of the sorbent increases by the mass of the absorbed gas. Since the resonance oscillation frequency of the tuning fork prongs depends on their dimensions and their mass, the added mass of the sorbent deposited on the prongs' surface will result in lowering of the oscillation frequency of the tuning fork. A temperature (T) sensor 1102, a pressure (P) sensor 1104, and a humidity (RH) sensor 1103 are similar to those as described above with respect to FIG. 8. A differential amp 1108 determines the frequency difference from the outputs of oscillators 1105 . . . 1106. An accurate signal for gas concentration may be calculated using an algorithm determined by circuitry in controller 1101 that has the frequency difference, pressure, temperature, and gas humidity as variables, in a manner as similarly described with respect to FIG. 8.

The inputs to the controllers 801-1101 measure gas concentration (and thus also sense a gas) with algorithms as described as follows. The frequency difference (dF) measured by a controller, as well as data from the pressure sensor (p), humidity sensor (RH), and temperature (T) sensor are further used to calculate the sensor response to hydrogen or other sensed gas with concentration c. The frequency difference is generally a function (S) of these parameters:

dF=S(p,RH,T,c)

During sensor calibration, the environmental parameters and gas concentration are changed in a controlled manner, for example, using an environmental chamber for changing T and p, mass flow controller settings to change gas concentration c, and gas humidifier for changing RH. During the sensor calibration, the frequency difference dF and other above mentioned parameters are recorded. For small variations in these parameters, the dF linearly depends on changes in any parameter. For example, if the pressure changes from p0 to p, it can be written

dF1=S(p0,RH,T,c)+(dS/dp)(p−p0)

For the change in concentration from c0 to c, it can be written in a similar way:

dF2=S(p,RH,T,c0)+(dS/dc)(c−c0)

and so on for different values of the parameters.

As a result of changes in all the parameters, there will be a set of “i” linear equations

dFi=S+(dS/dp)Δpi+(dS/dT)ΔTi+(dS/dRH)ΔRHi+(dS/dc)Δci

that are further solved by standard multiple linear regression method.

Solving these equations will provide a set of calculated constants (dS/dx), which will be further used as linear coefficients for the sensitivity function S:

dF=S0+S1*p+S2*T+S3*RH+S4*c

where S1=(dS/dp) and so on.

From this equation, the gas concentration c as a function of dF and other environmental parameters can be easily calculated:

c=(dF−S0−S1*p−S2*T−S3*RH)/S4

If, for example, the linear approximation for one of the parameters is not satisfactory, second order approximation can be used while using the same algorithm. For example, for pressure it will be

dF1=S(p0,RH,T,c)+(dS/dp)(p−p0)+(½)(d²S/dp²)(p−p0)²

and the concentration will be calculated as

c=(dF−S0−S11*p−S12*p2−S2*T−S3*RH)/S4

where

S11=(dS/dp) and S12=(½)*(d²S/dp²)

These parameters Si are stored in memory and are used by a controller to calculate gas concentration c.

Same approach is used to calculate the change in sorbent mass m.

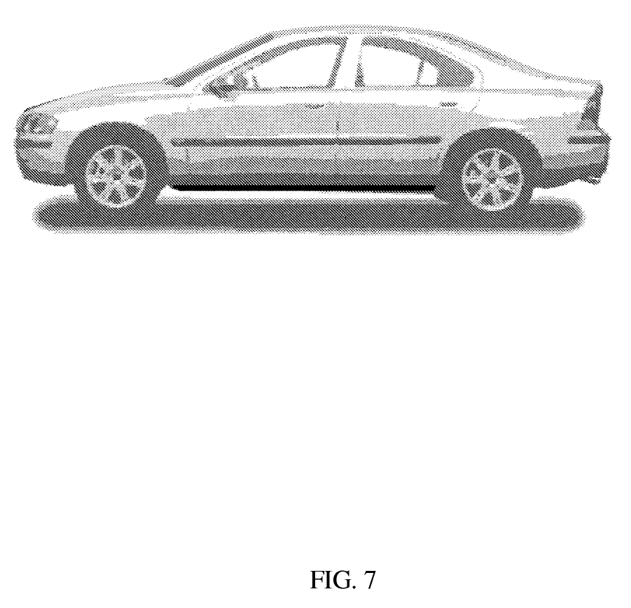

Thus, the described sensors may be used as a leak detector for many applications. For example, referring to FIG. 7, in a fuel cell powered car, the sensor may be installed near the fuel cell reactor, near the passenger seats, or in the exhaust system.

An LEL detector that uses the described sensor may be a portable handheld device, with a sensor incorporated in the device body, or placed at the end of an attachable sampling probe. The device may have indications of concentration on a display along with a sound alarm if the concentration of hydrogen reaches a certain critical level. Other applications include water electrolysers, hydrogen storage systems, industrial equipment, etc.

Improvements can be made to stabilize the sensor response against temperature, humidity, atmospheric pressure, quartz aging, and other conditions of operation.

A number of embodiments of the invention have been described. Nevertheless, it will be understood that various modifications may be made without departing from the spirit and scope of the invention.

What is claimed is:

1. A gas sensor comprising:
a first oscillator sealed in a hermetic package and having a first frequency output;
a second oscillator exposed to an environment containing a gas to be sensed, and having a second frequency output;
circuitry configured for determining if the gas is sensed by the second oscillator by producing a first frequency difference signal that is a difference between the first and second frequency outputs;
one or more environmental sensors configured for measuring an environmental variable of the environment containing the gas to be sensed, and having one or more environmental sensor outputs; and
a controller configured to determine a concentration of the sensed gas as a function of the first frequency difference signal and the one or more environmental sensor outputs.

2. The gas sensor as recited in claim 1, wherein the one or more environmental sensors comprises a temperature sensor configured for measuring a temperature of the environment containing the gas to be sensed.

3. The gas sensor as recited in claim 1, wherein the one or more environmental sensors comprises a pressure sensor configured for measuring a pressure of the environment containing the gas to be sensed.

4. The gas sensor as recited in claim 1, wherein the one or more environmental sensors comprises a humidity sensor configured for measuring a humidity of the environment containing the gas to be sensed.

5. The gas sensor as recited in claim 1, wherein the one or more environmental sensors comprises a temperature sensor configured for measuring a temperature of the environment containing the gas to be sensed, wherein the one or more environmental sensors comprises a pressure sensor configured for measuring a pressure of the environment containing the gas to be sensed, wherein the one or more environmental sensors comprises a humidity sensor configured for measuring a relative humidity of the environment containing the gas to be sensed, wherein the concentration (c) of the sensed gas is determined by the controller by a function
c=(dF−S0−S1*p−S2*T−S3*RH)/S4,
wherein dF is the frequency difference between the first and second frequency outputs, p is the pressure, T is the temperature, RH is the relative humidity, and S0, S1, S2, S3, S4 are constants, wherein S0 is an offset, wherein S1, S2, S3 are first derivatives of signals with respect to p, T, and RH, wherein S4 is a scaling factor.

6. A gas sensor comprising:
a first oscillator sealed in a hermetic package and having a first frequency output;
a second oscillator exposed to an environment containing a gas to be sensed, and having a second frequency output;
a third oscillator exposed to an environment containing another gas to be sensed, and having a third frequency output;
circuitry configured for determining if the gases are sensed by the second and third oscillators by producing first and second frequency difference signals that are a difference between the first and second, and first and third frequency outputs, respectively; and
a controller configured to determine a concentration of the sensed gases as functions of the first and second frequency difference signals and the one or more environmental sensor outputs.

7. The gas sensor as recited in claim 6, wherein the one or more environmental sensors comprises a temperature sensor configured for measuring a temperature of the environment containing the gas to be sensed.

8. The gas sensor as recited in claim 6, wherein the one or more environmental sensors comprises a pressure sensor configured for measuring a pressure of the environment containing the gas to be sensed.

9. The gas sensor as recited in claim 6, wherein the one or more environmental sensors comprises a humidity sensor configured for measuring a humidity of the environment containing the gas to be sensed.

10. The gas sensor as recited in claim 6, wherein the one or more environmental sensors comprises a temperature sensor configured for measuring a temperature of the environment containing the gas to be sensed, wherein the one or more environmental sensors comprises a pressure sensor configured for measuring a pressure of the environment containing the gas to be sensed, wherein the one or more environmental sensors comprises a humidity sensor configured for measuring a humidity of the environment containing the gas to be sensed, wherein the concentration (c) of the sensed gas is determined by the controller by a function
c=(dF1+kdF2−S0−S1*p−S2*T−S3*RH)/S4,
wherein dF1 is the first frequency difference, dF2 is the second frequency difference, p is the pressure, T is the temperature, RH is the relative humidity, and S0, S1, S2, S3, S4 are constants, wherein S0 is an offset, wherein S1, S2, S3 are first derivatives of signals with respect to p, T, and RH, wherein S4 and k are scaling factors.

11. The gas sensor as recited in claim 1, wherein the a second oscillator comprises a gas sorbent coating exposed to the environment, and further comprising circuitry for determining the mass of gas absorbed by the gas sorbent coating on the second oscillator by producing a frequency signal that is a difference between the first and second frequency outputs, wherein the controller determines a mass of the gas absorbed by the gas sorbent coating as a function of the first frequency difference signal and the one or more environmental sensor outputs.

12. A gas sensor comprising:
a first oscillator exposed to a gas environment and outputting a first frequency output;
a second oscillator comprising a gas sorbent coating and exposed to a gas environment, and outputting a second frequency output;
circuitry configured for determining a mass of gas absorbed by the sorbent coating on the second oscillator by producing a frequency signal that is a difference between the first and second frequency outputs;
a gas pressure sensor;
a humidity sensor;
a temperature sensor; and
a controller configured for determining a concentration of the mass of the absorbed gas as a function of the frequency difference signal and signals from the gas pressure sensor, humidity sensor, and the temperature sensor.

13. The gas sensor as recited in claim 12, wherein the temperature sensor is configured for measuring a temperature of the environment containing the gas to be sensed.

14. The gas sensor as recited in claim 12, wherein the pressure sensor is configured for measuring a pressure of the environment containing the gas to be sensed.

15. The gas sensor as recited in claim 12, wherein the humidity sensor is configured for measuring a humidity of the environment containing the gas to be sensed.

16. The gas sensor as recited in claim 12, wherein the mass (m) of the absorbed gas is determined by the controller by a function
m=(dF−S0−S1*p−S2*T−S3*RH)/S4,
wherein dF is the frequency difference between the first and second frequency outputs, p is the pressure, T is the temperature, RH is the relative humidity, and S0, S1, S2, S3, S4 are constants, wherein S0 is an offset, wherein S1, S2, S3 are first derivatives of signals with respect to p, T, and RH, wherein S4 is a scaling factor.
